(19) United States
(12) Patent Application Publication
(10) Pub. No.: US 2006/0195241 A1
(43) Pub. Date: Aug. 31, 2006

(54) Vehicle information notification device

(75) Inventor: Akira Nakagoshi, Toyota-Shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/341,369

(22) Filed: Jan. 30, 2006

(30) Foreign Application Priority Data
Feb. 17, 2005 (JP) 2005-040781

(51) Int. Cl. E05F 15/00

(52) U.S. Cl. 701/45

(57) ABSTRACT

In a vehicle information notification device, a crossing form information acquisition unit acquires crossing form information related to a geometric form of a crossing. A safe-condition check operation detection unit detects a right-and-left safe-condition check operation of a driver on an automotive vehicle. A safe-condition check state evaluation unit evaluates a safe-condition check state of the driver before entering the crossing based on both the crossing form information and the safe-condition check operation. Given information for supporting running of the vehicle in the crossing is notified to the driver based on an evaluation result from the safe-condition check state evaluation unit.

### BACKGROUND OF THE INVENTION

1. Field of the Invention

The present invention relates to a vehicle information notification device which notifies given information to a driver in order to support safe running of an automotive vehicle in an intersection.

2. Description of the Related Art

Conventionally, there is known the technology of detecting the features of an intersection based on the kind and existence of a traffic signal in the intersection, the crossing form, and the buildings near the intersection, and determining the degree of necessity of notification of given information in the intersection. For example, see Japanese Laid-Open Patent Application No. 2003-205797.

Moreover, there is known the technology of notifying, when it is determined based on the stop time of the vehicle in a stop position with a stop line, that the stop time has not reached a predetermined time and therefore a safe-condition check state of the driver is inadequate, the information for urging the driver to check the right-and-left safe conditions. For example, see Japanese Laid-Open Patent Application No. 2004-086363.

Moreover, there is known the technology of outputting, when it is determined, based on the result of image processing of the driver's face direction at the place where the checking of safe conditions is needed, such as an intersection, that the operation to check the safe conditions is neglected, an alarm to the driver. For example, see Japanese Laid-Open Patent Application No. 2000-142282.

Although the technology of Japanese Laid-Open Patent Application No. 2003-205797 can make the driver recognize the need for confirming the safe conditions, it does not detect or evaluates the actual safe-condition check state of the driver based on the degree of necessity determined, and therefore it is inadequate as the composition for supporting safe running of the vehicle in the intersection.

According to the technology of Japanese Laid-Open Patent Application No. 2004-086363, the outputting of an alarm to the driver is performed when it is determined, based on the stop time in the stop position, that the operation to check the right-and-left safe conditions is neglected, an alarm to the driver. This makes it possible to provide support for securing the increased safety of running of the vehicle in the intersection.

The technology of Japanese Laid-Open Patent Application No. 2004-086363 is advantageous in that the in-vehicle camera for detecting the driver's face direction is not used and simple composition is possible. However, there is a situation in which a long stop time of the vehicle does not insure necessarily sufficient right-and-left safe-condition check state. For example, in a certain situation, the vehicle may abruptly enter the intersection from the stop position while the driver does not perform the right-and-left safe-condition checking after waiting for the passage of other vehicles in the intersection. The technology of Japanese Laid-Open Patent Application No. 2004-086363 is not sufficient for evaluating the right-and-left safe-condition check state with sufficient accuracy.

According to the technology of Japanese Laid-Open Patent Application No. 2000-142282, the in-vehicle camera for detecting the driver's face direction is used, and, when compared with the above-mentioned composition in which the evaluation is performed based on the stop time only, it is expected that the right-and-left safe-condition check state of the driver can be evaluated with high reliability.

However, there are various kinds of geometric form of the actual intersections. In a certain intersection, the roads do not necessarily intersect each other at right angles, and they cross in a slanting direction. In another intersection, the roads intersect each other at an acute angle like a junction point.

For this reason, even when the in-vehicle camera for detecting the driver's face direction is used, the application of a uniform judgment criterion for detecting the driver's face direction would not be adequate for evaluating the right-and-left safe-condition check state in arbitrary intersections. There may be a case in which an alarm is not outputted to the driver even if the safe-condition check state is inadequate due to the geometric form of the intersection. Conversely, there may be a case in which an alarm is erroneously outputted to the driver although the safe-condition check state is adequate.

### SUMMARY OF THE INVENTION

An object of the present invention is to provide an improved vehicle information notification device in which the above-mentioned problems are eliminated.

Another object of the present invention is to provide a vehicle information notification device which is able to appropriately evaluate the right-and-left safe-condition check state of a driver according to the geometric form of an intersection.

In the vehicle information notification device of the present invention, it is taken into consideration that the driver's operation needed for checking the right-and-left safe-conditions at the intersection differs depending on the geometric form of the intersection.

In order to achieve the above-mentioned objects, the present invention provides a vehicle information notification device comprising: a crossing form information acquisition unit acquiring crossing form information related to a geometric form of a crossing; a safe-condition check operation detection unit detecting a right-and-left safe-condition check operation of a driver on an automotive vehicle; and a safe-condition check state evaluation unit evaluating a safe-condition check state of the driver before entering the crossing based on both the crossing form information acquired by the crossing form acquisition unit and the safe-condition check operation detected by the safe-condition check operation detection unit, wherein given information for supporting running of the vehicle in the crossing is notified to the driver based on an evaluation result from the safe-condition check state evaluation unit.

The above-mentioned vehicle information notification device of the invention may be configured so that the crossing form information includes a crossing angle of an intersecting road at the crossing to a running road on which the vehicle is running, and the safe-condition check operation includes a motion of a driver's face and/or a motion of a driver's look.

The above-mentioned vehicle information notification device of the invention may be configured so that the crossing form information includes a crossing angle of an intersecting road at the crossing to a running road on which the vehicle is running, and the check state evaluation unit is configured to evaluate the safe-condition check state based on whether a direction of a driver's face exceeds a reference angle determined in accordance with the crossing angle included in the crossing form information.

The above-mentioned vehicle information notification device of the invention may be configured so that the crossing form information includes a crossing angle of an intersecting road at the crossing to a running road on which the vehicle is running, and the check state evaluation unit is configured to evaluate the safe-condition check state based on an integration time for which a direction of a driver's face exceeds a reference angle determined in accordance with the crossing angle included in the crossing form information.

The above-mentioned vehicle information notification device of the invention may be configured so that a reference angle is determined for each of a right side and a left side of the driver independently and asymmetrically by setting a direction of a face of the driver in a standard posture to zero degree.

The above-mentioned vehicle information notification device of the invention may be configured so that the vehicle information notification device further comprises an information notification determining unit determining whether the notification of the given information to the driver is performed, based on the evaluation result from the safe-condition check state evaluation unit.

The above-mentioned vehicle information notification device of the invention may be configured so that the vehicle information notification device further comprises a traffic restriction state detecting unit detecting a traffic restriction state of a crossing where the vehicle enters, wherein the information notification determining unit is configured to determine whether the notification is performed, based on the traffic restriction state detected by the traffic restriction state detecting unit and the evaluation result from the safe-condition check state evaluation unit.

The above-mentioned vehicle information notification device of the invention may be configured so that the vehicle information notification device further comprises a stop line detecting unit detecting whether a stop line exists in a crossing where the vehicle enter, wherein the information notification determining unit is configured to determine that the notification of the given information to the driver is not performed, when it is detected by the stop line detection unit that any stop line does not exist in the crossing.

The above-mentioned vehicle information notification device of the invention may be configured so that the direction of the driver's face is replaced with a direction of a driver's look, and the check state evaluation unit is configured to evaluate the safe-condition check state based on whether the direction of the driver's look exceeds the reference angle.

According to the present invention, it is possible to provide a vehicle information notification device which can evaluate the right-and-left safe-condition check state of the driver appropriately according to the geometric form of an intersection.

### BRIEF DESCRIPTION OF THE DRAWINGS

Other objects, features and advantages of the present invention will become apparent from the following detailed description when read in conjunction with the accompanying drawings.

FIG. 1 is a block diagram showing the composition of a vehicle information notification device in an embodiment of the invention.

FIG. 2 is a block diagram showing the functional composition of a navigation ECU of this embodiment.

FIG. 3A and FIG. 3B are diagrams showing examples of the intersection state in which the crossing angles differ.

FIG. 4 is a flowchart for explaining the routine of the characteristic processing performed by the navigation ECU of this embodiment.

FIG. 5 is a diagram showing the face direction (reference angle β) which should be turned to the right and left at the time of performing the right-and-left check operation before the intersection.

FIG. 6 is a diagram showing the state of an intersection where the driver's right-and-left safe operation (face angle θ) is performed.

FIG. 7 is a diagram showing the map for evaluating the right-and-left safe-condition check state which is used in the vehicle information notification device in another embodiment of the invention.

### DETAILED DESCRIPTION OF PREFERRED EMBODIMENTS

A description will now be provided of an embodiment of the present invention with reference to the accompanying drawings.

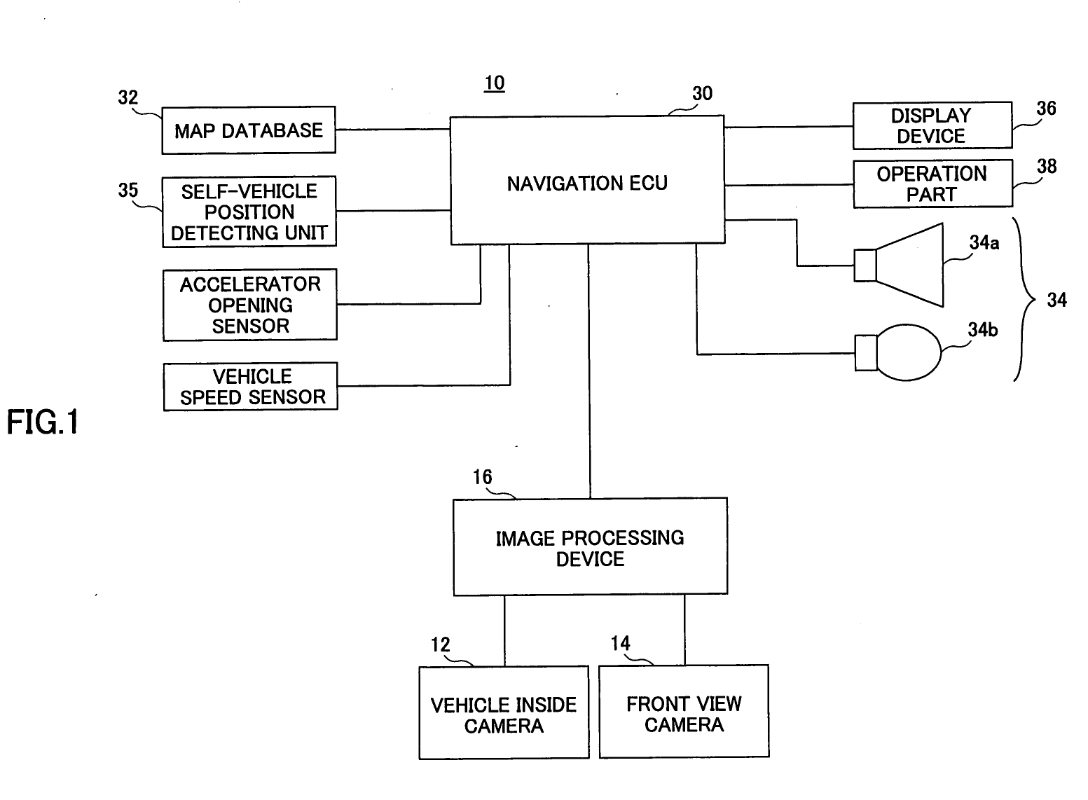

FIG. 1 shows the composition of the vehicle information notification device in an embodiment of the invention.

As shown in FIG. 1, the vehicle information notification device 10 is mainly constituted by an electronic control unit 30 (which will be called navigation ECU 30) which generally controls the navigation related devices. The navigation ECU (electronic control unit) 30 is composed of a CPU (central processing unit), a ROM, a RAM, I/O devices, etc.

Various kinds of electronic parts used in the automotive vehicle (a vehicle speed sensor, an accelerator opening sensor, a braking force sensor, and various ECUs) are connected to the navigation ECU 30 via a suitable bus, such as a CAN (controller area network).

Moreover, connected to the navigation ECU 30 are: a the map database 32 in which map data are stored in a recording medium, such as a DVD and a CD-ROM; a display device 36, such as a liquid crystal display which outputs an image of a map display and a course guidance display; a voice input/output device 34 including a loudspeaker 34a and a microphone 34b; and an operation part 38 including a touch panel used as the user interface.

The navigation ECU 30 is provided with a self-vehicle position detecting unit 35. The self-vehicle position detecting unit 35 includes a GPS (global positioning system) receiver, a beacon receiver, an FM multiplex receiver, and various sensors, such as a vehicle speed sensor, and a gyro sensor.

In the self-vehicle position detecting unit 35, the GPS signal which is outputted by a GPS Satellite is received by the GPS receiver via a GPS antenna. The self-vehicle position detecting unit 35 converts the received GPS signal into a given format signal, and supplies the resulting signal to the navigation ECU 30.

The navigation ECU 30 computes a present vehicle position and a present vehicle direction based on the GPS signal or the signals supplied from the various sensors.

The map data is stored in the map database 32. Similar to the normal map data, the map data stored in the map database 32 contains various kinds of information including the coordinate information of respective nodes corresponding to intersections, the coordinate information of respective nodes corresponding to juncture/branch points of highways, the link information which interconnects the adjoining nodes, the road width information corresponding to respective links, the road classification information of national roads, prefectural roads and highways corresponding to respective links, the passing regulation information of respective links, and the passing regulation information between the respective links.

An image processing device 16 is connected to the navigation ECU 30. A vehicle inside camera 12 (which is, for example, a CCD camera) which is disposed in the passenger compartment of the vehicle is connected to the image processing device 16. By using the image processing device 16, a safe-condition check operation of the driver is detected through the image processing.

The vehicle inside camera 12 is arranged in the position near the face position of the driver in the passenger compartment so that an image of the driver's face can be captured by the vehicle inside camera 12. The image processing device 16 receives the image data of the image captured by the vehicle inside camera 12 and subjects the received image data to the image processing. By using the image processing device 16, a detection signal which indicates a motion of the driver's face or a change of a direction of the driver's face is supplied to the navigation ECU 30.

Moreover, a CCD (stereo) camera 14 (which is also called the front view camera 14) for detecting a stop line may be connected to the image processing device 16. The front view camera 14 is disposed so that an image of the scenery ahead of the vehicle can be captured. For example, the front view camera 14 is secured near the room mirror in the passenger compartment of the vehicle.

The image processing device 16 receives the image data of the image captured by the front view camera 14 and subjects the received image data to the image processing. By using the image processing device 16, the presence of a stop line is detected, and the distance from the position of the self-vehicle to the stop line concerned is computed using the principle of triangulation. The image processing device 16 supplies the computed distance to the stop line to the navigation ECU 30, when the presence of the stop line is detected.

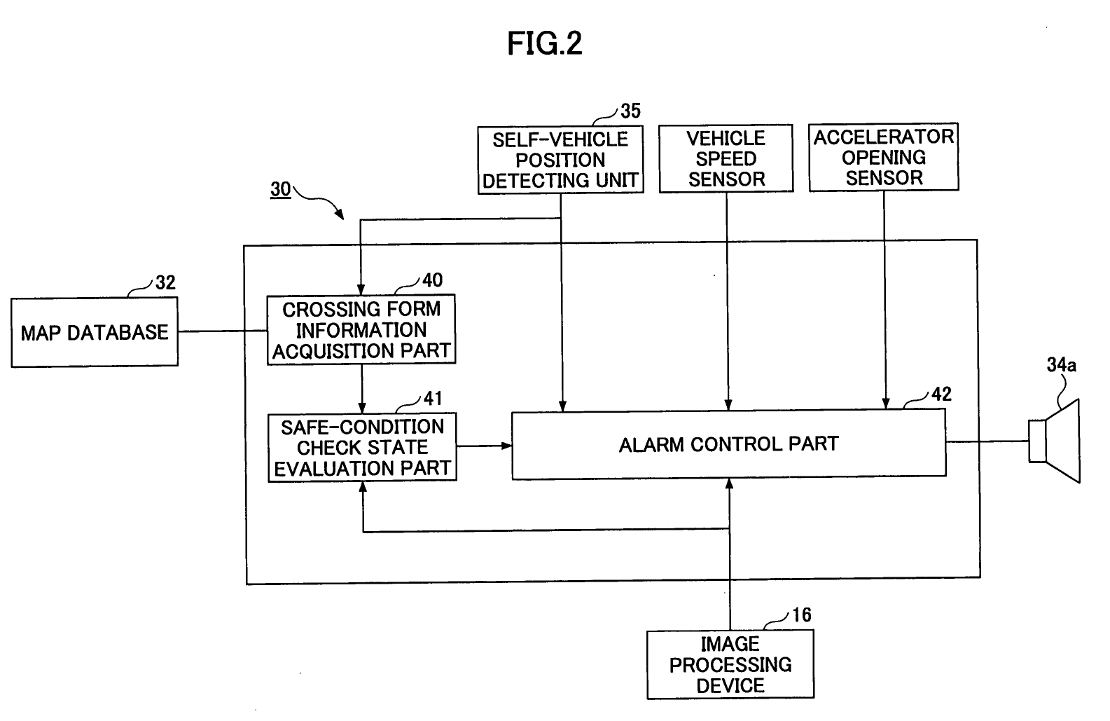

FIG. 2 shows the functional composition of the navigation ECU 30 of this embodiment.

As shown in FIG. 2, the navigation ECU 30 of this embodiment comprises a crossing form information acquisition part 41, a safe-condition check-state evaluation part 42, and an alarm control part 42.

The crossing form information acquisition part 40 acquires information related to a geometric form of a crossing or intersection. The safe-condition check state evaluation part 41 evaluates a safe-condition check state of a driver before entering the crossing. The alarm control part 42 controls the notification of given information for supporting the running of the vehicle in a candidate stop area.

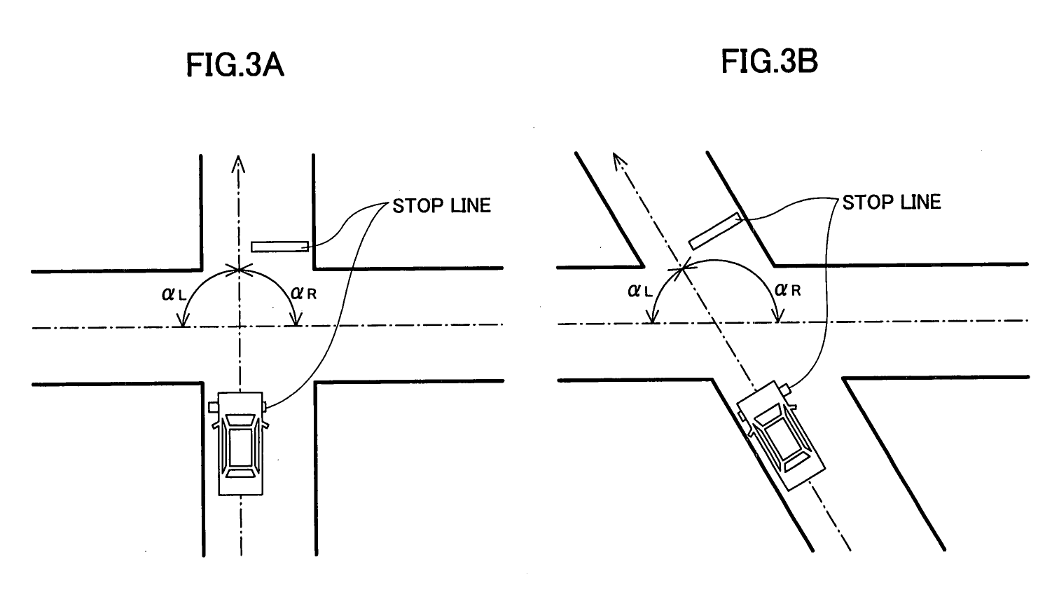

Specifically, the crossing form information acquisition part 40 creates and acquires the information related to the crossing form of the intersection (which information will be called the crossing form information) based on the map data in the map database 32. This crossing form information is information which can represent the geometric form of the intersection, for example, the intersecting mode of respective roads which constitute the intersection. Typically, the crossing form information includes information related to an angle (a crossing angle) of an intersecting road (or the direction of the intersecting road), as shown in FIG. 3A or FIG. 3B, to the running road on which the self-vehicle is running (or to the direction of travel of the self-vehicle).

The crossing form information may be created beforehand for every crossing or every intersection as the map data in the map database 32. Or, the crossing form information may be created at the time of necessity based on the angle which is made by the road links which constitute an intersection.

The crossing form information for the crossing which is actually crossed by the vehicle may be created at the time of the actual running of the vehicle, based on the result of image-processing of the image captured by the front view camera 14. The crossing form information created in this case may be additionally stored in the map database 32, and may be used in the case of the future or subsequent running of the vehicle in the crossing concerned. From this viewpoint, it is preferred that the map database 32 is constituted by a rewritable recording medium (which is typically a hard disk).

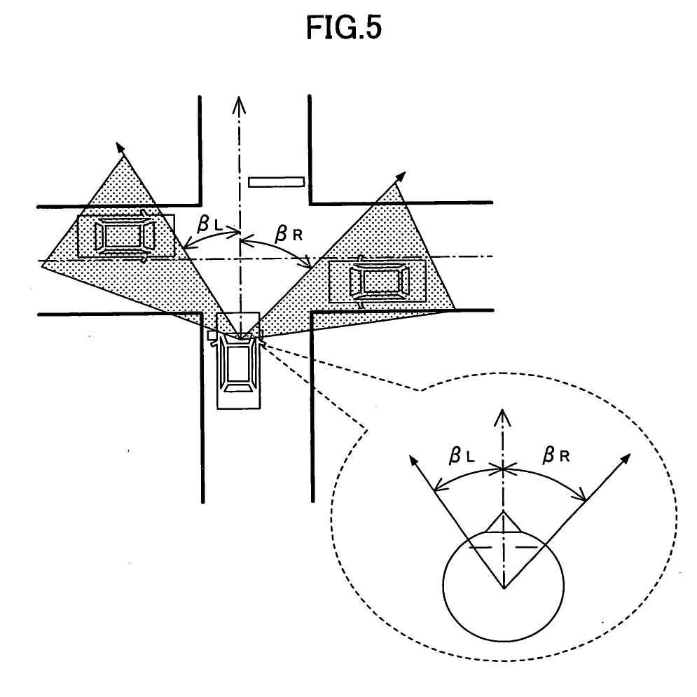

The safe-condition check state evaluation part 41 applies evaluation criteria to the result of detection of the right-and-left safe-condition check operation of the driver (or a direction of a driver's face) before entering the crossing, and evaluates the right-and-left safe-condition check state of the driver before entering the crossing. The evaluation criteria are set up beforehand based on the direction of the driver's face which should be turned to the right and the left at the time of the right-and-left check operation before entering the crossing. For example, the reference angles β (shown in FIG. 5) are used as the required minimum angles of the direction of the driver's face that should be turned to the right and the left.

The direction of the driver's face is represented in the form of a face angle θ to one of the right side and the left side of the driver when the direction of travel of the vehicle (or the extended direction of the running road) is set to zero degree. In this case, when both the face angles θ to the right side and the left side are larger than the reference angles β, it is determined that the evaluation criteria are met. And it is evaluated that the right-and-left safe-condition check state of the driver is adequate, which will be described later.

The alarm control part 42 determines the necessity of notification of a variety of given information (alarm) to the driver based on the result of evaluation from the safe-condition check state evaluation part 41. When it is determined that the notification is needed, the alarm control part 42 performs the notification of the variety of given information for urging the driver to perform a right-and-left safe-condition check operation.

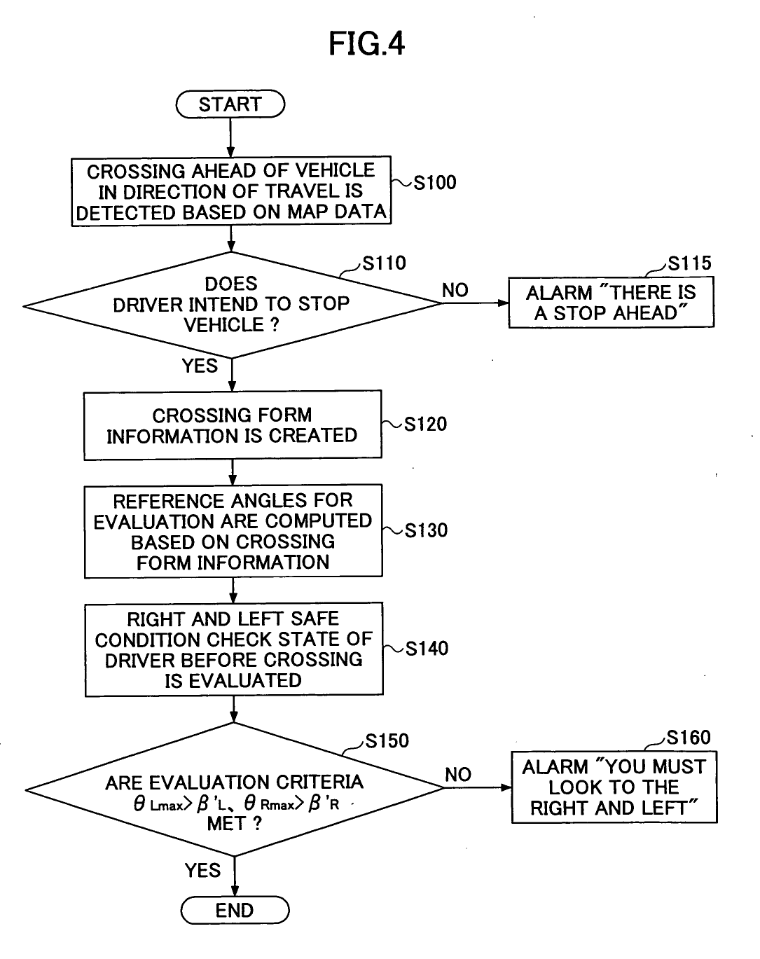

FIG. 4 is a flowchart for explaining the routine of the characteristic processing performed by the navigation ECU 30 of this embodiment.

Suppose that, in this embodiment, the self-vehicle position information detected by the self-vehicle position detecting unit 32 and the self-vehicle speed information detected by the vehicle speed sensor are supplied to the navigation ECU 30 at respective intervals of a predetermined period, and the navigation ECU 30 always computes the latest vehicle position and the latest vehicle speed and grasps them.

As shown in FIG. 4, at step S100, the crossing form information acquisition part 40 detects a crossing ahead of the vehicle traveling direction based on the crossing information of the map data of the map database 32. For example, based on the self-vehicle position information from the self-vehicle position detecting unit 35, the crossing form information acquisition part 40 acquires the crossing information related to the given area ahead of the self-vehicle position from the map data of the map database 32, and detects the position of the crossing nearest to the position of the self-vehicle.

At step S110, the alarm control part 42 computes the distance from the present vehicle position to the crossing based on the crossing information (or the position information of the crossing) of the map data. When the computed distance to the crossing is in the range of a predetermined distance, the alarm control part 42 determines whether the driver intends to stop the vehicle.

In this step S110, for example, it is determined whether the vehicle speed is decreased, or it is determined whether the treading force on the accelerator pedal is released, based on the running state of the vehicle (or the history of the vehicle speed or deceleration) and/or the driver's operation mode (or the detection of accelerator pedal operation based on an output signal of the accelerator opening sensor, the detection of brake pedal operation based on output signals of the master cylinder pressure sensor and the braking force sensor, etc.).

When it is determined that there is no intention of the driver to stop the vehicle, the alarm control part 42 causes the alarm information (for example, a voice message like “there is a stop ahead”) which notifies the driver of the presence of a stop line to be outputted (step S115).

On the other hand, when it is determined that the driver intend to stop the vehicle, the control progresses to step S120.

At step S120, the crossing form information acquisition part 40 creates the crossing form information related to the crossing detected at the step S100.

In this embodiment, the crossing form information acquisition part 40 creates the crossing angles αL and αR (see FIG. 3A or FIG. 3B) which indicate the direction of an intersecting road relative to the direction (or the direction of travel) of the self-vehicle as the crossing form information, based on the map data in the map database 32. The crossing angles αL and αR are the left-hand side angle and the right-hand side angle for the driver respectively (αL+αR=180 degrees).

A more accurate method of definition of the crossing angles is as follows. When an x-axis is taken to make the extended direction of an intersecting road of the crossing on the right-hand side of the driver the positive side of the x-axis and a y-axis is taken to make the direction of travel of the self-vehicle the positive side of the y-axis, the crossing angle αL and the crossing angle αR are respectively defined as being the angle in the 2nd quadrant between the x-axis and the y-axis and the angle in the 1st quadrant between the x-axis and the y-axis.

According to the above-mentioned method of definition, in the case of the intersection of FIG. 3A, the crossing angles αL and αR are defined as being equal to 90 degrees. In the case of the intersection of FIG. 3B where the extended direction of the running road of the vehicle is slanted leftward to the direction of the intersecting road, the crossing angles αL and αR are defined such that the conditions αL (acute angle)<90 and 90<αR (obtuse angle) are met.

The above-mentioned definition method has been described for the sake of convenience of explanation. Alternatively, any other kind of method of definition of the crossing angles may be used instead according to the present invention.

In the step S120, the direction of the self-vehicle may be determined based on the direction information according to the GPS signal or based on the output signal of a yaw rate sensor, a direction meter, etc.

Alternatively, the direction of the self-vehicle may be determined as being the same as the extended direction of the link corresponding to the direction of the running road of the self-vehicle. The direction of the intersecting road may be determined as being the same as that of the extended direction of the link corresponding to the intersecting road based on the map data of the map database 32.

At step S130, the evaluation criteria for the crossing detected at the step S100 are determined based on the crossing form information of the crossing detected. In this respect, the directions of the driver's face (the face angles θL, θR) which should be turned to the right and left at the time of the right-and-left safe-condition check operation are different from each other even in the case of the symmetrical form crossing where the crossing angles are 90 degrees.

For example, under the road traffic rule of the left-hand side running like in Japan, it is necessary that the face angle θR by which the driver's face should be turned to the right at the time of right-hand side safe-condition checking is larger than the face angle θL by which the driver's face should be turned to the left at the time of left-hand side safe-condition checking.

For this reason, the evaluation criteria may be determined such that the right reference angle and the left reference angle are different from each other. In this embodiment, the reference angle β is set up for each of the right side and the left side of the driver (i.e., βL, βR) as shown in FIG. 5.

In this embodiment, at the step S130, the reference angle β is corrected based on the crossing form information and the final evaluation criteria are determined. This is because the crossing form is different for every crossing and also the right-and-left safe-condition check operation required for each crossing is different depending on the crossing form concerned.

Namely, in the case of the slanting-form intersection of FIG. 3B where the extended direction of the running road of the vehicle is slanted leftward to the direction of the intersecting road, it is not necessary for the driver to turn, at the time of left-hand side safe-condition checking, the face to the left-hand side greatly when compared with the symmetrical form crossing of FIG. 3A, and it is necessary for the driver to turn, at the time of right-hand side safe-condition checking, the face to the right-hand side greatly.

Accordingly, at the step S130, the correction of the reference angle β is not performed for the symmetrical-form crossing as shown in FIG. 3A where the crossing angles are about 90 degrees, but the correction of the reference angle β is performed for the slanting-form crossing as shown in FIG. 3B where the extended direction of the running road of the vehicle is slanted to the direction of the intersecting road. For example, a correction reference angle β′ may be computed from the reference angle β in accordance with the equation: β′=β+(α−90) (where α is the crossing angle).

In this embodiment, the right and left correction reference angles β and β′ are respectively computed in accordance with the following the equations:
βL′=βL+(αL−90) and
βR′=βR+(αR−90).

After the evaluation criteria are determined in this manner, at step S140, the safe-condition check state evaluation part 41 detects the right-and-left safe-condition check operation of the driver before entering the crossing based on the result of image capturing of the vehicle inside camera 12 (or the result of image processing from the image processing device 16). In this embodiment, the maximum face angles θL max and θR max of the driver in the horizontal direction are detected at the step S140.

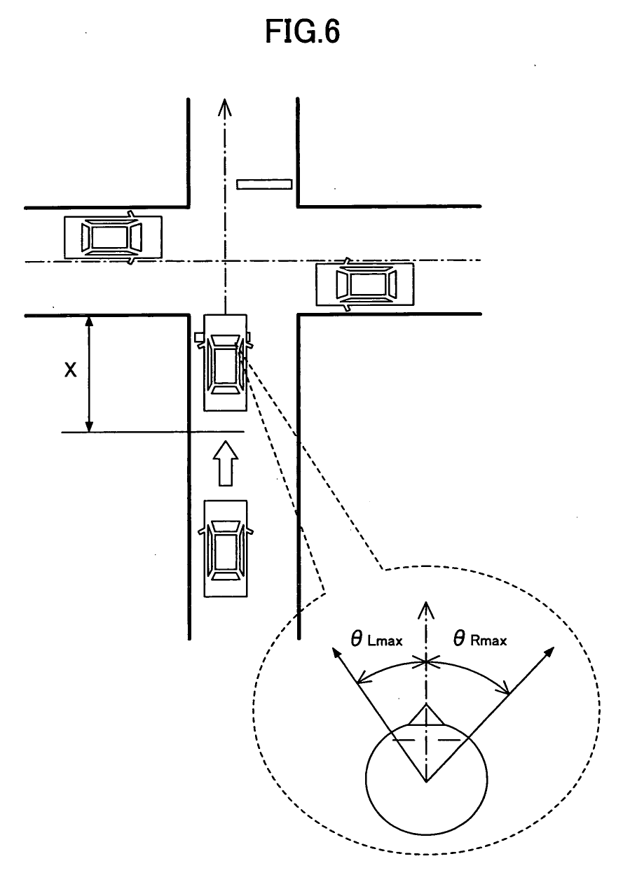

At step S150, the safe-condition check state evaluation part 41 applies the evaluation criteria determined at the step S130 to the maximum face angles θL max and θR max in the horizontal direction detected at the step S140, and evaluates the right-and-left safe-condition check state of the driver before entering the crossing. For example, the right-and-left safe-condition check operation (or the direction of the driver's face) of the driver being evaluated in this case may be a right-and-left safe-condition check operation which is performed by the driver after the vehicle passes the point of a given distance X [m] before the stop line as shown in FIG. 6, or may be a right-and-left safe-condition check operation which is performed by the driver during a stop of the vehicle on the stop line (namely, X=0).

Specifically, at the step S150, it is determined whether the maximum face angles θL max and θR max of the driver in the horizontal direction detected at the step S140 are larger than the correction reference angles βL′ and βR′ (which are, in case where no correction is performed, the same as the reference angles βL and βR). Namely, it is determined at the step S150 whether the evaluation criteria: θL max>βL′ and θR max>βR′ are met.

When it is determined in the step S150 that the maximum face angles θL max and θR max of the driver in the horizontal direction are larger than the correction reference angles βL′ and βR′, the right and left safe-condition check state of the driver is judged as being adequate. The processing of FIG. 4 is finished without notifying the given information to the driver.

On the other hand, when it is determined in the step S150 that the maximum leftward face angle θL max is smaller than the correction reference angle βL′ or the maximum rightward face angle θR max is smaller than the correction reference angle βR′, the safe-condition check state of the driver is judged as being inadequate. And the control progresses to step S160.

At step S160, the alarm control part 42 causes the alarm information for urging the driver to perform the right-and-left safe-condition check operation to be outputted at the time of start of the vehicle from the stop position or at the time of passing the stop position (when a stop is not made), for example, based on the sensor output values, such as those from the vehicle speed sensor and the accelerator opening sensor.

At this time, the alarm control part 42 may cause a voice message like “you must look to the right and left”) be outputted. t it becomes should be outputted via the loudspeaker 34a.

In addition, the present invention is not limited to the above-mentioned mode of the notification of the given information. If the given information being notified is to urge the driver to perform the right-and-left safe-condition checking, any kind of the notification of visually or acoustically noticeable information is applicable.

Moreover, when the maximum leftward face angle θL max is smaller than the correction reference angle βL′ but the maximum rightward face angle θR max is larger than the correction reference angle βR′, only the left side safe-condition check state of the driver is judged as being inadequate. In this case, the notification of the given information in the step S160 may be performed by outputting a voice message like “you must look to the left”.

Similarly, when the maximum rightward face angle θR max is smaller than the correction reference angle βR′ but the maximum leftward face angle θL max is larger than the correction reference angle βL′, only the right side safe-condition check state of the driver is judged as being inadequate. In this case, the notification of the given information in the step S160 may be performed by outputting a voice message like “you must look to the right”.

According to the above-described embodiment, the evaluation criteria used for evaluating the safe-condition check state of the driver before entering the crossing are appropriately determined in the step S130 based on the geometric form information of the crossing concerned. It is possible to prevent effectively the problems resulting from the geometric form of the crossing, such as the problem in which the notification of the given information is not performed even if the safe-condition check state of the driver is inadequate, or the problem in which the notification of the given information is performed erroneously although the safe-condition check state of the drive is adequate.

More specifically, in the case of the leftward-slanting-form intersection as shown in FIG. 3B, a correction reference angle βL′ smaller than the reference angle βL and a correction reference angle βR′ larger than the reference angle βR are set up as the evaluation criteria. Accordingly, when the maximum leftward face angle θL max of the driver is smaller than the reference angle βL but it is larger than the correction reference angle βL′, it is determined that the safe-condition check state is sufficient, and unnecessary notification of the given information is avoided.

Moreover, when the maximum rightward face angle θR max of the driver is larger than the reference angle βR but it is smaller that the correction reference angle βR′, it is determined that the safe-condition check state is inadequate, and necessary notification of the given information is performed.

According to the above-described embodiment, it is possible to evaluate appropriately the right-and-left safe-condition check state of the driver based on the geometric form information of the crossing concerned. Therefore, it is possible to increase the reliability and usefulness of the notification of the given information for supporting safe running of the vehicle.

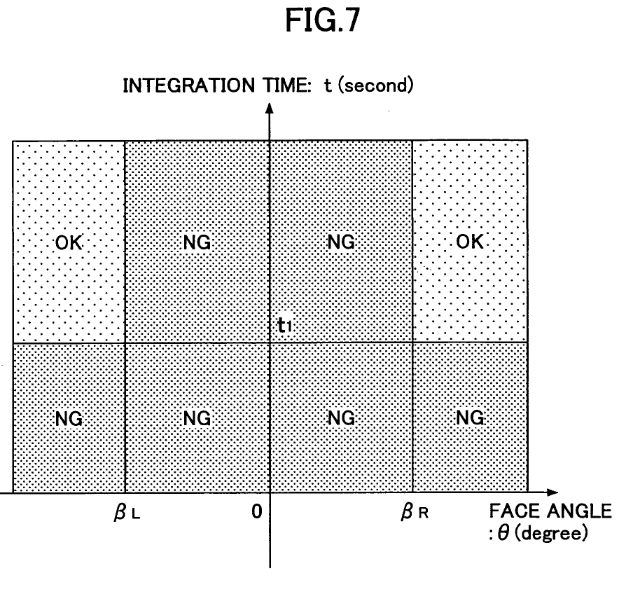

FIG. 7 is a diagram showing the map for evaluating the right-and-left safe-condition check state which may be used in the step S150 in another embodiment of the invention. In the evaluation map of FIG. 7, suppose that the horizontal axis is made as the face angle θand the vertical axis is made as the integration time t.

In the evaluation map of FIG. 7, the areas where the leftward and rightward face angles θL and θR are larger than the reference angles βL and βR and the integration time t is larger than a predetermined threshold value t1 are considered as the areas where the evaluation criteria are met (which areas are indicated by the letters “OK” in FIG. 7). Other areas in the evaluation map of FIG. 7 are considered as the areas where the evaluation criteria are not met (which areas are indicated by the letters “NG” in FIG. 7).

In the present embodiment in which the evaluation map of FIG. 7 is used, when the integration time t for which the leftward face angle θL is larger than the reference angle βL exceeds the threshold value t1, it is determined that the left side safe-condition check state of the driver is adequate. Similarly, when the integration time t for which the rightward face angle θR is larger than the reference angle βR exceeds the threshold value t1, it is determined that the right side safe-condition check state of the driver is adequate.

On the contrary, when the face angle θ is smaller than the reference angle β or when the integration time t is smaller than the threshold value t1, it is determined that the safe-condition check state of the driver is inadequate.

Similar to the previously described embodiment, the reference angles βL and βR are corrected based on the crossing form information. The correcting method in this embodiment may be the same as in the previously described embodiment.

According to the embodiment of FIG. 7, the right-and-left safe-condition check state of the driver is evaluated not only based on whether the driver's face is turned to the right and left by an adequately large angle larger than the reference angle, but also based on whether the integration time (or the safe-condition check time) for which the driver's face is turned by an adequately large angle larger than the reference angle is larger than the threshold value t1.

In addition to the effects of the previously described embodiment, it is possible for the embodiment of FIG. 7 to evaluate the safe-condition check state of the driver at an increased level of accuracy.

Next, modifications of the above-mentioned embodiment which may be made according to the present invention will be explained.

In a modification of the above-mentioned embodiment, detecting more exactly the presence of a crossing or intersection where the driver must perform the right-and-left safe-condition checking may be taken into consideration.

In the above-mentioned embodiment, the crossing detected at the step S100 is limited to the crossing where the stop line is provided on the running road of the self-vehicle.

In a case in which it cannot be judged directly from the map data as to which of the running road of the self-vehicle and the interesting road of the crossing where the stop line is provided, an estimation as to whether the stop line exists there may be carried out based on the result of analysis of the priority relation between the running road of the self-vehicle and the intersecting road with the road classification.

For example, the details of such estimation method is disclosed in Japanese Laid-Open Patent Application No. 2004-086363 and the disclosed method may be adopted for the above-mentioned modification.

In an automotive vehicle equipped with an imaging unit, such as the CCD camera 14, the exact road information which was actually acquired when the vehicle passed the crossing with the stop in the past may be additionally stored in the map database 32, and it may be used in the case of a subsequent running of the vehicle before entering the same crossing.

From the same viewpoint, a determination as to whether the necessity for the notification of the given information to the driver before entering the crossing arises may be carried out according to the traffic restriction state of the crossing detected in the above step S100.

For example, when the color of the traffic signal installed in the crossing is blue, it may be determined that a right-and-left check operation is not needed or there is little need. In this case, the determination in the above step S150 as to whether the evaluation criteria are met may not be performed, or changing the evaluation criteria to a smaller threshold value may be performed. Alternatively, the notification of the given information to the driver in the above step S160 may be inhibited or controlled.

The color of a traffic signal ahead of the vehicle may be determined based on the image data of the image captured by the front view camera 14. Other traffic restriction states may be taken into consideration, such as the blinking of the traffic signal in red (which urges the driver to stop the vehicle before the stop line).

Another modification of the above-mentioned embodiment may be made according to the present invention. In this modification, the result of the image processing of the image data obtained by using the front view camera 14 is used at the time of making a determination as to whether the given information is notified to the driver.

In this case, the presence of an intersection with a stop line where the notification of the given information to the drive must be performed can be detected in the above step S100 with good accuracy and reliability, based on the result of the detection of the stop line by using the front view camera 14. In addition, the distance from the vehicle to the stop line which is computed based on the result of the image processing may be used to compute the given distance X in the step S150.

The present invention is not limited to the above-described embodiments, and variations and modifications may be made without departing from the scope of the present invention.

For example, in the above-described embodiment, the load of the image processing is taken into consideration and the safe-condition check state of the driver is evaluated based on the motion (direction) of the driver's face. Alternatively, the evaluation may be carried out based on a motion of a driver's look (or a direction of driver's line of vision).

In addition, in the above-described embodiment, the safe-condition check state of the driver is evaluated based on whether the reference angle β is exceeded or not. Alternatively, a certain reference angle range may be set up and the evaluation may be carried out based on whether the face angle θ of the driver falls within the reference angle range or based on whether an integration time for which the face angle θ of the driver falls within the reference angle range exceeds a given reference time.

In such alternative embodiment, a lower limit of the reference angle range may be corrected similar to the correction of the reference angle β.

In the above-described embodiment, the evaluation criteria (reference angle β) for evaluating the safe-condition check state of the driver are set up and corrected according to the geometric form of the crossing, for the sake of good understanding of the invention. However, according to the present invention, making a further correction to the evaluation criteria according to other factors is not excluded. For example, a further correction to the corrected reference angle β′ may be made according to the building state in the neighborhood of the crossing. In a case of the crossing under conditions of low visibility, the amount of correction to the reference angle β may be enlarged so that the evaluation of the safe-condition check state of the driver can be carried out in accordance with the enlarged corrected reference angle β′.

Further, the present application is based upon and claims the benefit of priority of Japanese patent application No. 2005-040781, filed on Feb. 17, 2005, the entire contents of which are incorporated herein by reference.

What is claimed is:

1. A vehicle information notification device, comprising:
a crossing form information acquisition unit acquiring crossing form information related to a geometric form of a crossing;
a safe-condition check operation detection unit detecting a right-and-left safe-condition check operation of a driver on an automotive vehicle; and
a safe-condition check state evaluation unit evaluating a safe-condition check state of the driver before entering the crossing based on both the crossing form information acquired by the crossing form acquisition unit and the safe-condition check operation detected by the safe-condition check operation detection unit,
wherein given information for supporting running of the vehicle in the crossing is notified to the driver based on an evaluation result from the safe-condition check state evaluation unit.

2. The vehicle information notification device according to claim 1 wherein the crossing form information includes a crossing angle of an intersecting road at the crossing to a running road on which the vehicle is running, and the safe-condition check operation includes a motion of a driver's face and/or a motion of a driver's look.

3. The vehicle information notification device according to claim 1 wherein the crossing form information includes a crossing angle of an intersecting road at the crossing to a running road on which the vehicle is running, and the check state evaluation unit is configured to evaluate the safe-condition check state based on whether a direction of a driver's face exceeds a reference angle determined in accordance with the crossing angle included in the crossing form information.

4. The vehicle information notification device according to claim 1 wherein the crossing form information includes a crossing angle of an intersecting road at the crossing to a running road on which the vehicle is running, and the check state evaluation unit is configured to evaluate the safe-condition check state based on an integration time for which a direction of a driver's face exceeds a reference angle determined in accordance with the crossing angle included in the crossing form information.

5. The vehicle information notification device according to claim 3 wherein a reference angle is determined for each of a right side and a left side of the driver independently and asymmetrically by setting a direction of a face of the driver in a standard posture to zero degree.

6. The vehicle information notification device according to claim 1 further comprising an information notification determining unit determining whether the notification of the given information to the driver is performed, based on the evaluation result from the safe-condition check state evaluation unit.

7. The vehicle information notification device according to claim 6 further comprising a traffic restriction state detecting unit detecting a traffic restriction state of a crossing where the vehicle enters, wherein the information notification determining unit is configured to determine whether the notification is performed, based on the traffic restriction state detected by the traffic restriction state detecting unit and the evaluation result from the safe-condition check state evaluation unit.

8. The vehicle information notification device according to claim 6 further comprising a stop line detecting unit detecting whether a stop line exists in a crossing where the vehicle enter, wherein the information notification determining unit is configured to determine that the notification of the given information to the driver is not performed, when it is detected by the stop line detection unit that any stop line does not exist in the crossing.

9. The vehicle information notification device according to claim 3 wherein the direction of the driver's face is replaced with a direction of a driver's look, and the check state evaluation unit is configured to evaluate the safe-condition check state based on whether the direction of the driver's look exceeds the reference angle.
